(19) United States
(12) Patent Application Publication
(10) Pub. No.: US 2023/0351346 A1
(43) Pub. Date: Nov. 2, 2023

(54) CUSTOMIZABLE RULES-BASED PAYMENT PLAN MANAGEMENT

(71) Applicant: MASTERCARD INTERNATIONAL INCORPORATED, PURCHASE, NY (US)

(72) Inventors: Michael TUOZZO, Morristown, NJ (US); Tony CONTE, Westbury, NY (US); Mark SAVOYE, Hartsdale, NY (US); Briana JAKEWAY, Manasquan, NY (US)

(21) Appl. No.: 18/055,197

(22) Filed: Nov. 14, 2022

Related U.S. Application Data
(60) Provisional application No. 63/336,999, filed on Apr. 29, 2022.

(51) Int. Cl. G06Q 20/10; G06Q 20/40

(52) U.S. Cl. CPC G06Q 20/102; G06Q 20/405

(57) ABSTRACT

Examples provide customizable rules-based payment plan management. A customized set of rules are applied to a user account data associated with a delinquent account having a past-due amount owed by a user. The set of rules are customized by a payee of the delinquent account. A payment plan is selected from a plurality of available payment plans based on application of the rules to the user account data. One or more payment methods are selected. An offer, including the selected payment plan and payment method(s), is generated for the user that is customized for the user based on the user account data. The generated offer is presented to the user for acceptance or rejection. The offer includes a payment term for at least partially satisfying a past-due amount owed by the user. If the user accepts the offer, the status of the account is changed from delinquent to non-delinquent.

### CROSS-REFERENCE TO RELATED APPLICATION(S)

This application claims the benefit of and priority to U.S. Provisional Application No. 63/336,999 filed Apr. 29, 2022, entitled “Customizable Rules-Based Payment Plan Management”, the entirety of which is hereby incorporated by reference herein.

### BACKGROUND

When customers fail to make timely payments on a credit account, the account can become delinquent. Delinquent accounts may be turned over to a debt collection agency, but collection efforts may fail to collect significant amounts. Moreover, fees charged by collection agencies further reduce the benefits of using such agencies. Alternatively, a merchant or lender can offer customers a repayment plan. However, most repayment plans are a one-size-fits-all type of plan that is unsuitable for many customers, resulting in inefficient use of computing resources, and a negative experience for customers.

### SUMMARY

Some examples provide a system for customized rules-based payment plan management. A smart payment policy manager applies a customized set of rules to user account data associated with a delinquent account having a past-due amount owed by a user. A payment plan is selected from a plurality of payment plans based on application of the rules to the user account data. A payment method is selected from a plurality of payment methods based on the results of the application of the customized set of rules. An offer is generated. The offer includes the selected payment plan and the at least one payment method. The generated offer is presented to the user for acceptance or rejection. The offer includes a payment term for at least partially satisfying a past-due amount owed by the user. If the user accepts the offer, the status of the account is changed from delinquent to non-delinquent.

Other examples provide a method for customized rules-based payment method and payment plan management. Account data is associated with a delinquent account having a past-due amount owed by a first user. A set of customized rules are constructed from a plurality of available rules based on a configuration received from a second user. The set of customized rules are applied to the account data associated with the delinquent account. A payment plan from a plurality of payment plans is selected based on a result of application of the customized rules to the account data. An offer is presented to the first user via a user interface for acceptance or rejection. The offer includes the selected payment plan and a payment method for at least partially satisfying a past-due amount owed by the first user. The account status is changed from delinquent status to non-delinquent status in response to user acceptance of the offer.

Still other examples provide a computer storage medium having computer-executable instructions that, upon execution by a processor of a computer, cause the processor to present a plurality of available rules for application to account data associated with a delinquent account having a past-due amount owed by a first user. A set of customized rules are constructed from the plurality of available rules based on a configuration received from a second user. The set of customized rules are applied to the account data associated with a delinquent account having the past-due amount owed by the first user. A payment plan is selected from a plurality of payment plans based on a result of application of the customized rules to the account data. An offer is presented to the first user via a user interface for acceptance or rejection. The offer includes the selected payment plan and a payment method for at least partially satisfying a past-due amount owed by the first user.

### BRIEF DESCRIPTION OF THE DRAWINGS

FIG. 1 is an exemplary block diagram illustrating a system 100 for smart payment policy management.

FIG. 2 is an exemplary block diagram illustrating a smart collect system 200 including a rules engine for generating customized payment plan offers.

FIG. 3 is an exemplary block diagram illustrating a system 300 including a payment service provider for collecting payments in accordance with an accepted custom payment plan.

FIG. 4 is an exemplary block diagram illustrating a computing device 400 hosting a smart collect policy manager for generating customized payment plan offers.

FIG. 5 is an exemplary block diagram illustrating a smart collect policy manager 500.

FIG. 6 is an exemplary process flow chart 900 illustrating operation of a computing device to generate a customized smart collect policy for selecting payment plans.

FIG. 7 is an exemplary flow chart 1000 illustrating operation of a computing device to provide a customized offer to a user.

FIG. 8 is an exemplary flow chart 1100 illustrating operation of a computing device to use a customized policy for selecting payment plans and payment methods for delinquent user accounts.

FIG. 9 is an exemplary flow chart 1200 illustrating operation of a computing device to obtain user response data and offer acceptance data associated with a customized payment offer.

FIG. 10 is an exemplary UI 1000 including a set of rules applied to user data to select a customized payment plan for a user.

FIG. 11 is an exemplary UI 1100 of a user login screen for authenticating a user.

FIG. 12 is an exemplary UI 1200 including a pre-qualified repayment plan offer notification.

FIG. 13 illustrates a computing apparatus 2300 according to an embodiment as a functional block diagram.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Customers of merchants providing goods and/or services having payment due accounts sometimes experience difficulties making scheduled payments on time due to temporary circumstances, such as illness, a job change, family emergency, natural disaster, or other unexpected event. Typically, when accounts become delinquent, a third-party collection agency may be employed to obtain repayment from the payer. In these situations, the third-party collection agency's actions may appear intrusive, somewhat intimidating, and even stressful for many payers. Moreover, third-party collection agencies are frequently only able to collect a fraction of the amount due on these types of delinquent accounts.

Collection efforts by third-party collection agencies are frequently a discouraging experience for the payer due to the high financial impact and potentially numerous collector calls and letters which may be received by the payer. Likewise, the collection process can be a labor-intensive process with high financial and reputational risk for the merchant/biller which can result in impaired relationships with customers. The collection agencies, moreover, typically receive disproportionate fee revenues of twenty-five to as high as fifty percent average debt collection agency fees, resulting in a negative experience for both the customers and the merchants.

Referring to the figures, examples of the disclosure enable a policy manager that generates customized offers for users having payment accounts that are in default. The customized offers provide a payment plan and payment options for the user to resume payments on the account and bring the account back into current payment status without involving third-party collection agencies or collection activities which may be onerous or unduly stressful for payers. In this manner, account management is handled in an efficient manner that is designed to provide a more positive experience for both the payer and the payee.

In other examples, the system generates customized payment plans and payment methods which are selected for each payer based on payer questionnaire responses describing aspects of each payers current unique situation and account data associated with the delinquent account. In this manner, payment plans are customized to best accommodate each unique payer and payee situation in a manner that is inclusive and nonconfrontational.

In some examples, the policy manager includes a merchant facing user interface that includes a rules engine for defining payment plans, establishing payer questionnaire variables, deploying customized collection policies, uploading billing/customer data, generating metrics and reporting data. The merchant is a biller or payee on the payment account. This simplifies merchant interaction and efficiency via the user interface.

In still other examples, the system includes a policy application programming interface (API) integrated into the merchant's digital payment channels. Upon payer authentication, the policy API requests a payment plan for presentation to the payer, including payment plans selected based on customizable rules. Upon payment plan acceptance, the API triggers request back to collect for billing and/or reporting. In this manner, the policy manager in provides a diversified, multi-rail option to enhance account management while preventing account from becoming delinquent and increasing financial inclusion.

The conventional computing device operates in an unconventional manner at least by generating customized policies, based on rules, used to select payment plans and payment methods for users based on user-specific account data. In this manner, the computing device is used in an unconventional way, and allows user-specific self-curing of delinquent payment accounts in a flexible and inclusive manner that provides a positive experience for both payers and payees without involving third-party collection agencies. Resolution of delinquent accounts in this manner is technologically efficient, precise, and targeted, using only the computing resources needed to implement the customized repayment plan, thereby improving the functioning of the underlying computing device.

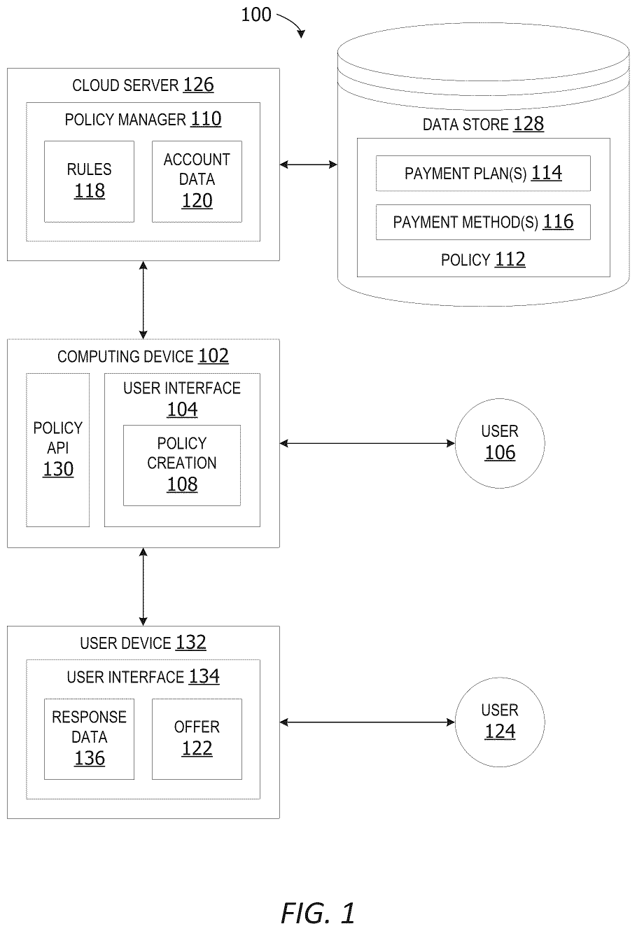

Referring again to FIG. 1, an exemplary block diagram illustrates a system 100 for smart payment policy management. The system 100 includes a computing device 102 having a user interface 104. The computing device 102 represents any device executing computer-executable instructions (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

The user interface 104, in some examples, includes a graphics card for displaying data to the user and receiving data from the user. The user interface 104 can also include computer-executable instructions (e.g., a driver) for operating the graphics card. Further, the user interface 104 can include a display (e.g., a touch screen display or natural user interface) and/or computer-executable instructions (e.g., a driver) for operating the display. The user interface 104 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

In this example, a user 106, such as a merchant or other payee, utilizes the user interface 104 for policy creation 108. A policy includes the customized rules and payment plans created for a user. The policy is applied to payers to select a per-payer custom payment plan.

In some examples, the policy creation 108 guided by a policy manager 110 enables the user to create a customized policy 112 including the user-created payment plan(s) 114 and/or one or more payment method(s) 116. The user that creates the policy may be referred as a merchant or operator.

The policy 112 also includes a set of user-created rules 118. The rules 118 are applied against user account data 120 associated with a delinquent user account to generate an offer 122. The offer 122 includes a payment plan selected for the user 124 payer associated with the delinquent account. The user 124 is a payer that owes an amount due which is past due. In other words, the user 124 is associated with a delinquent payment account.

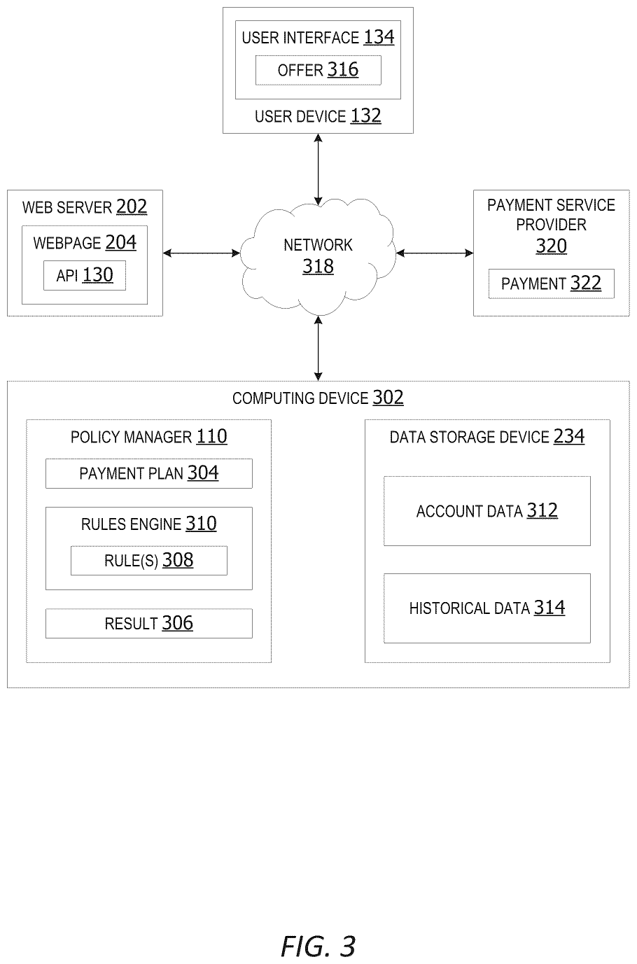

In this non-limiting example, the policy manager 110 is hosted on a cloud server 126. The cloud server 126 is a logical server providing services to the computing device 102 or other clients, such as, but not limited to, the user device 132. The cloud server 126 is hosted and/or delivered via a network, such as, but not limited to, the network 3xx in FIG. 3 below. In some non-limiting examples, the cloud server 126 is associated with one or more physical servers in one or more data centers. In other examples, the cloud server 126 is associated with a distributed network of servers. However, the examples are not limited to the policy manager 110 hosted on a cloud server. In other examples, the policy manager 110 is hosted on a computing device, such as, but not limited to, the computing device 102.

The customized payment plan(s) 114 include two or more payment plans created by the user 106 via the user interface 104. The policy manager 110, in some examples, provides prompts, templates with Tillable fields, example payment plans and other guidance assisting the user in creating the customized payment plans. The payment plans 114 can be customized based on the type of store, services, products sold, services offered, business model or other circumstances unique to each user. For example, if the user sells durable (multi-use) goods, the payment plans may include longer time-periods for payment of purchase price than another user selling single-use or disposable goods.

The payment plan(s) 114 and/or available payment method(s) 116 in each policy are stored in a data store 128. The data store 128 can include a physical data storage device associated with the computing device 102, a data store remote from the computing device 102 and/or a cloud storage. In some examples, the account data 120 for each user payer is also stored on a data store, such as, but not limited to, the data store 128. In such examples, the account data 120 is downloaded from the data store and onto the cloud server or other device hosting the policy manager 110.

When a user 124 payer (customer) logs into a website, portal page or other webpage associated with the user 106 payee (merchant) via the user device 132, a policy application programming interface (API) 130 calls the policy manager 110 to present an offer generated based on the customized policy 112. The offer 122 includes at least one payment plan 114 and/or the payment method(s) 116 for presentation to the user 124.

The user device 132 represents any device executing computer-executable instructions. The user device 132 can be implemented as a mobile computing device, such as, but not limited to, a wearable computing device, a mobile telephone, laptop, tablet, computing pad, netbook, gaming device, and/or any other portable device. The user device 132 includes at least one processor and a memory.

In this example, the policy manager 110 analyzes the account data 120 for the account of the user 124, applies the set of rules 118 customized by the merchant user 106 and returns the payment plan and payment method indicated by the rules 118. The policy manger 110 returns the offer 122 to the user device 132 of the user 124 for presentation to the user 124. The user reviews the offer 122 via a user interface 134. If the user indicates acceptance of the offer, the policy manager 110 triggers, initiates, generates, or otherwise causes billing of the user 124 in accordance with the payment terms in the payment plan in the accepted offer 122. For example, the policy manager 110 configures, or causes to configure, a server to bill the user 124. In the example of FIG. 1, the user's acceptance or rejection of the offer is returned to the policy manager 110 in the response data 136.

In other examples, if the user 124 rejects the first offer 122, the system 100 selects a second offer having a second payment plan selected from the plurality of payment plan(s) 114. The second offer is returned to the user device for presentation of the offer to the user via the user interface 134. If the user accepts the second offer, the system triggers billing of the user (payee) in accordance with the payment terms specified in the payment plan and payment method of the accepted second offer. In other examples, only a single offer is presented. If the user rejects the initial offer, no additional offers of payment plans for taking the user's account out of delinquency is offered.

In still other examples, the policy manger 110 applies the set of rules 118 to the account data 120 to select two or more best payment plans which are most likely to be suitable for the user 106 (merchant) and the user 124 (customer). The offer 122 provided to the user 124 in these examples includes two or more payment plans. The user 124 selects and accepts one of the payment plans from the offered payment plans. The user 124 is then billed in accordance with the payment term(s) of the selected payment plan and payment method in the offer that is accepted by the user payee.

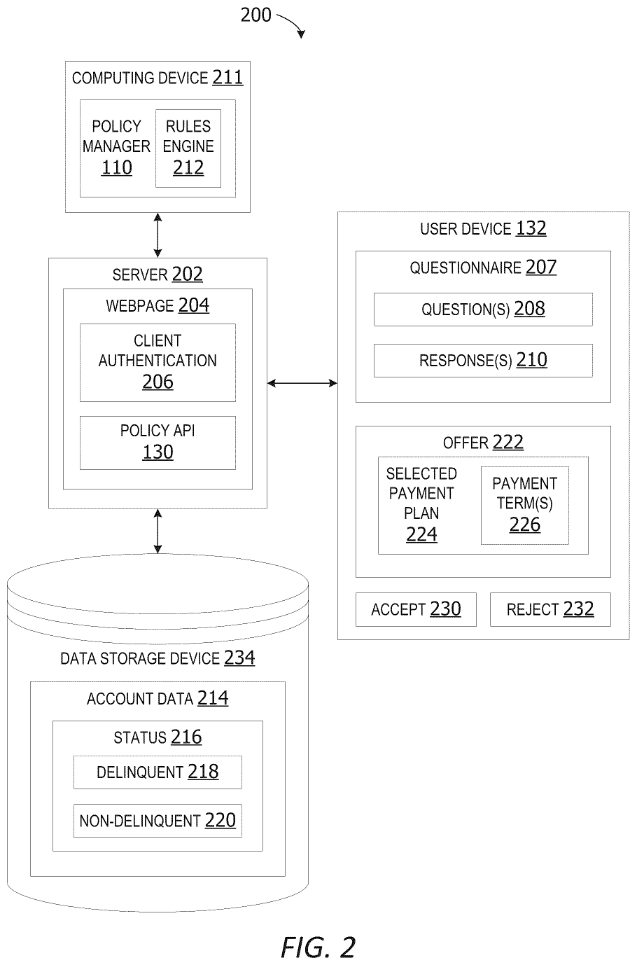

FIG. 2 is an exemplary block diagram illustrating a smart collect system 200 including a rules engine for generating customized payment plan offers. In this example, a web server 202 hosts a webpage 204 associated with a merchant or other payee associated with a delinquent payment account of a customer/payer. The user (payer) logs into the webpage 204 using a username and password or another authentication. The server 202 performs the client authentication 206 verifying an identity of the user associated with the user device 132. The server 202 is a computing device, such as, but not limited to, the computing device 102 in FIG. 2. In other examples, the server 202 is implemented as a cloud server.

Once the user is authenticated, the policy API 130 calls the policy manager 110 on the computing device 211 to request an offer for remediation of the user's delinquent payment account. In this example, the policy manager 110 sends a customized questionnaire 207 including one or more question(s) 208 to the user device 132 for review by the user payer. The questionnaire 207 is a customized set of questions created for the merchant based on the merchant's business, types of goods or services, etc. In other examples, the merchant creates the questionnaire by providing data to the policy manager 110. The data may be provided via fillable forms, data fields, a questionnaire creation wizard, menus, etc. In other examples, a machine learning component of the policy manager 110 creates the questionnaire based on user-specific data provided by the merchant/payee and other feedback.

The computing device 211 is a device having a processor and a memory, such as, but not limited to, the computing device 102 in FIG. 1. However, the examples are not limited to a computing device. In other examples, the policy manager 110 is hosted on a cloud server.

The response(s) 210 to each of the question(s) 208 are provided by the payer via a user interface. The response(s) 210 in some examples are selected from a set of two or more predefined responses for each question, like a multiple-choice answer format. For example, a first question in the question(s) 208 can include an answer A or an answer B. The user selects either answer A or answer B. In other examples, the user enters a text-based answer into a field rather than selecting a pre-defined answer choice from a set of choices.

In some examples, a rules engine 212 of the policy manager 110 applies a set of rules to the account data 214 and the responses(s) 210 provided by the payer. In one example, the rules engine applies a set of if-then type rules to the account data to select a payment plan from a plurality of payment plans.

The account data 214 includes data associated with the delinquent payment account. The account data 214 can include a total amount due, a date due, a previous payment history, type of product or service purchased, previous purchase history, amount past due, amount already paid, etc.

In other examples, the account data 214 includes a status 216 of the account. The status 216 indicates whether the account is delinquent 218 or non-delinquent 220. An account is not delinquent if there is no current payment amount that is past due. An account is delinquent if there is a payment that has not yet been paid and the payment amount is past due.

The rules engine 212 applies the rules to select a payment plan and/or a payment method from the one or more available payment method(s), such as, but not limited to, the payment method(s) 116 in FIG. 1. The selected payment plan 224 includes one or more payment term(s) 226. The payment term(s) 226 specify a payment amount and frequency of payments. In these examples, the payment amount and/or payment frequency terms are such that it should be easier for the payer to stay current on payments without becoming delinquent again in future. In this example, the payment amount specified in the payment term(s) of the selected payment plan is less than the payment terms specified in the user's current delinquent payment account. In other examples, the payment term(s) 226 include a “hold” time-period or pause payments for a given period of time. The hold or pause is a deferral of payments until the payer is able to restart payments. In still other examples, the payment term(s) may include forgiveness of part of the amount owed. In such examples, the user is required to pay only part of the original amount owed. In other examples, the payment term(s) may include refinancing, a lower interest rate, an extended repayment period or other favorable terms to assist the payer.

The offer 222 provided to the payer includes a selected payment plan 224 and payment method(s). The user can accept 230 or reject 232 the offer 222.

In this non-limiting example, the account data 214 for the payer is optionally stored in a data storage device 234. The data storage device 234 is a data store for storing account-related data, such as, but not limited to, the data store 128 in FIG. 1. The data storage device 234 can include one or more different types of data storage devices, such as, for example, one or more rotating disks drives, one or more solid state drives (SSDs), and/or any other type of data storage device. The data storage device 234 in some non-limiting examples includes a redundant array of independent disks (RAID) array. In other examples, the data storage device 234 includes a database.

The data storage device 234 in this example is included within the computing device 102, attached to the computing device, plugged into the computing device, or otherwise associated with the computing device 102. In other examples, the data storage device 234 includes a remote data storage accessed by the computing device via a network, such as a remote data storage device, a data storage in a remote data center, or a cloud storage.

FIG. 3 is an exemplary block diagram illustrating a system 300 including a payment service provider for collecting payments in accordance with an accepted custom payment plan. In some examples, the policy manager 110 is hosted on a computing device 302. The computing device is a device, such as, but not limited to, the computing device 102 in FIG. 1 and/or the computing device 211 in FIG. 2. The policy manager 110 selects a payment plan 304 for a payer based a result 306 of application of a set of rules 308 to account data 312, historical data 314 and/or other user-provided data. The rules engine 310 creates and/or stores the rule(s) 308. In some examples, the rules are stored in a data storage device 234.

In some examples, the user logs into the merchant payee's webpage 204 hosted on the web server 202. The policy API 130 is driven from the customer-facing side of the system. The API 130 calls the policy manager 110. The policy manager 110 downloads or otherwise requests the account data 312 for the user. The policy manager applies the rules 308 to the account data to obtain a customized payment plan for the user. The account data is optionally stored in a data store, such as, but not limited to, the data storage device 234.

The offer 316 including the selected payment plan 304 is transmitted from the policy manager 110 to the web server 202 for transmittal to the user device 132 via the network. In other examples, the policy manager 110 sends the offer directly to the user device for presentation to the user via a user interface 134 of the user device 132.

The network 318 is implemented by one or more physical network components, such as, but without limitation, routers, switches, network interface cards (NICs), and other network devices. The network 318 is any type of network for enabling communications with remote computing devices, such as, but not limited to, a local area network (LAN), a subnet, a wide area network (WAN), a wireless (Wi-Fi) network, or any other type of network. In this example, the network 318 is a WAN, such as the Internet. However, in other examples, the network 318 is a local or private LAN.

If the user payer agrees to the offer 316, billing of the user is triggered under the terms of the accepted offer. The merchant/payee may utilize a payment service provider 320 to process payment 322 received from the payer. The payment service provider 320 can optionally include a bank, credit card company, cryptocurrency payment service, or any other payment service provider for processing payments received from the payer. If payment is received, the delinquent account status is changed to indicate that the account of the payer is now current and no longer past due or delinquent.

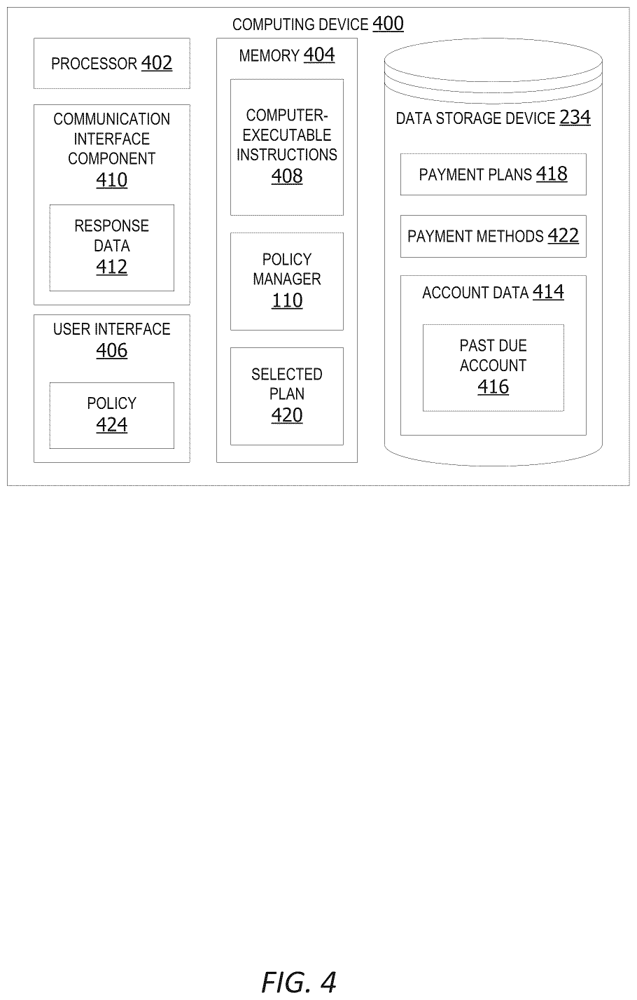

FIG. 4 is an exemplary block diagram illustrating a computing device 400 hosting a smart collect policy manager for generating customized payment plan offers. The computing device 400 is a device such as, but not limited to, the computing device 102 in FIG. 1, the computing device 211 in FIG. 2 and/or the computing device 302 in FIG. 3.

In some examples, the computing device 400 has at least one processor 402 and a memory 404. The computing device 400 in other examples includes a user interface 406.

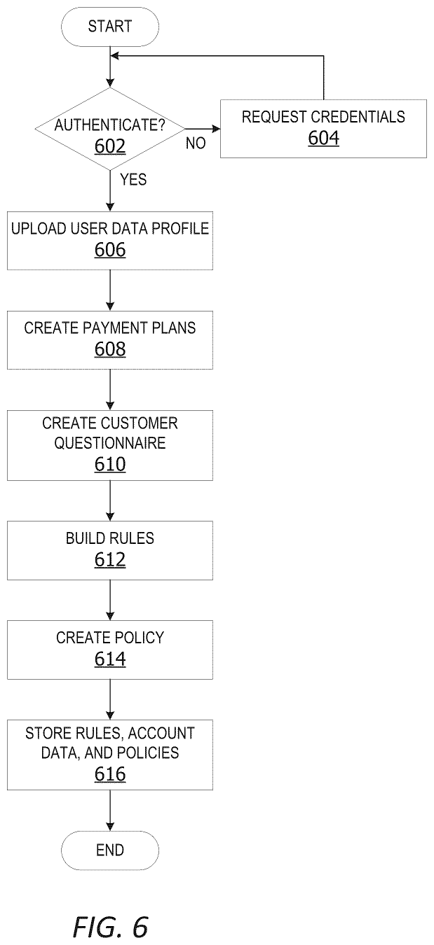

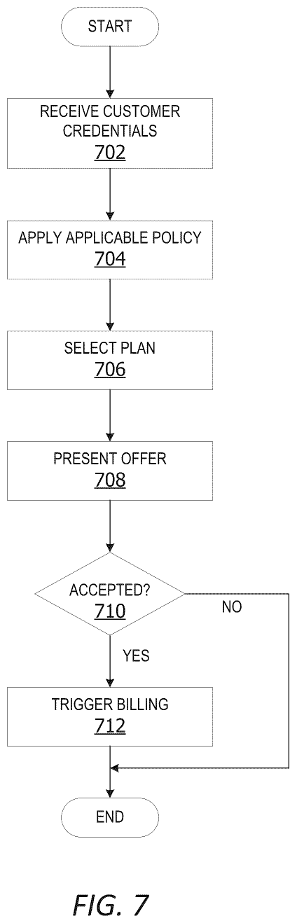

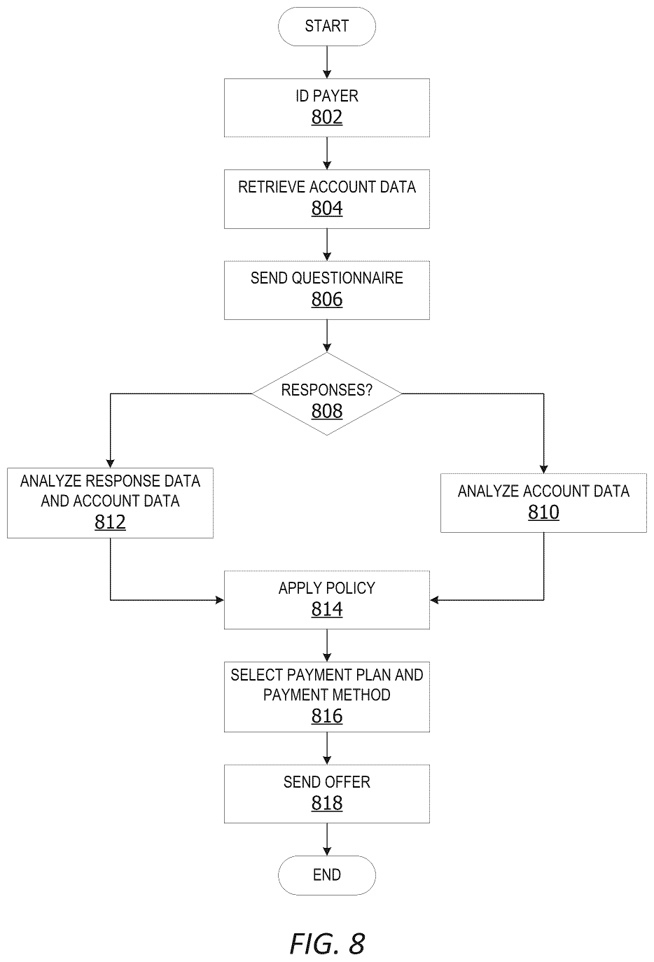

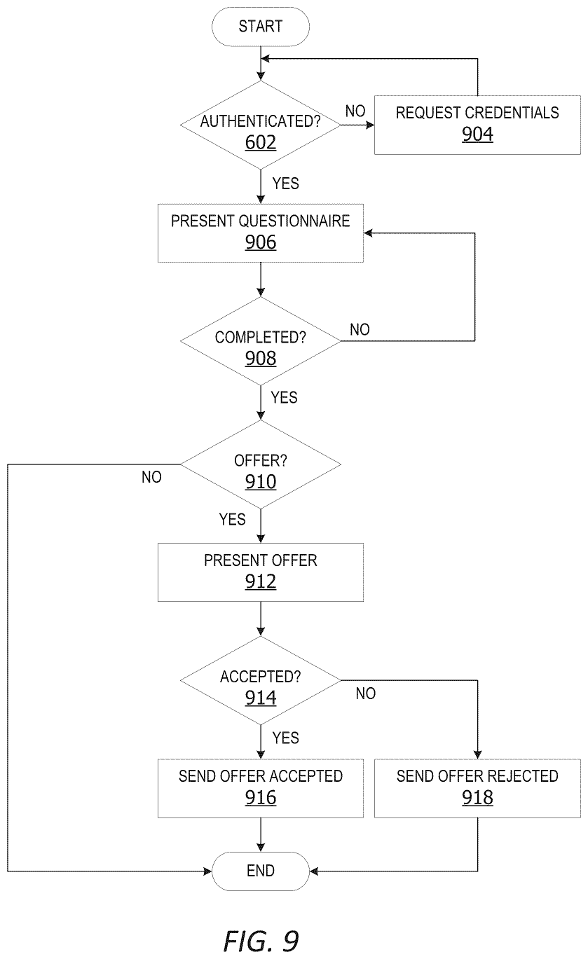

The processor 402 includes any quantity of processing units and is programmed to execute the computer-executable instructions 408. The computer-executable instructions 408 is performed by the processor 402, performed by multiple processors within the computing device 400 or performed by a processor external to the computing device 400. In some examples, the processor 402 is programmed to execute instructions such as those illustrated in the figures (e.g., FIG. 6, FIG. 7, FIG. 8, and FIG. 9).

The computing device 400 further has one or more computer-readable media such as the memory 404. The memory 404 includes any quantity of media associated with or accessible by the computing device 400. The memory 404 in these examples is internal to the computing device 400 (as shown in FIG. 1). In other examples, the memory 404 is external to the computing device (not shown) or both (not shown). The memory 404 can include read-only memory and/or memory wired into an analog computing device.

The memory 404 stores data, such as one or more applications. The applications, when executed by the processor 402, operate to perform functionality on the computing device 400. The applications can communicate with counterpart applications or services such as web services accessible via a network, such as, but not limited to, the network 318 in FIG. 3. In an example, the applications represent downloaded client-side applications that correspond to server-side services executing in a cloud.

In some examples, the computing device 400 optionally includes a communications interface component 410. The communications interface component 410 includes a network interface card and/or computer-executable instructions (e.g., a driver) for operating the network interface card. Communication between the computing device 400 and other devices, such as but not limited to a user device, cloud server, or data store, can occur using any protocol or mechanism over any wired or wireless connection. In some examples, the communications interface component 410 is operable with short range communication technologies such as by using near-field communication (NFC) tags.

In this example, the policy manager 110 receives response data 412 from a user device or data store via the communications interface component 410. The policy manager 110 applies the rules found in the user-created customized policy 424 to the account data 414 for the delinquent account having a past due amount 416 and/or the response data 412 to select a payment plan from a plurality of customized payment plans 418. The selected plan 420 and payment methods 422 are presented to the payer as an offer.

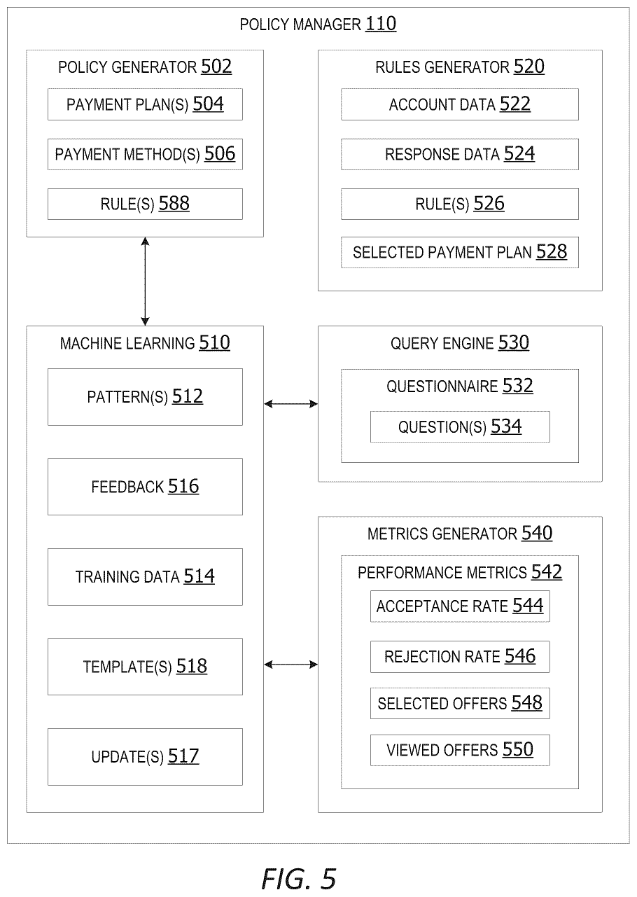

FIG. 5 is an exemplary block diagram illustrating a smart collect policy manager 110. The policy manager 110 in some examples includes a policy generator 502 for assisting and/or guiding a user in creating customized payment plan(s) 504, selecting payment method(s) 506 and/or creating customized rule(s) 508 for creating offers. In some examples, the policy generator 502 includes templates 518 and/or examples to assist the user in creating the payment plans and rules. In other examples, a machine learning 510 analyzes user-provided data to identify pattern(s) and auto-generate customized payment plan(s) and/or rules for the user. In these examples, the machine learning 510 is trained using training data 514 including sets of labeled questionnaires, payment plans and rules for users in the same or similar fields as the user. Feedback 516 from the user is utilized to fine-tune or generate update(s) 517 to the payment plans, rules, offers or other data generated by the machine learning. In still other examples, the machine learning creates and/or updates templates utilized by the user in creating the customized per-merchant payment plans, customized rules and/or customized offers.

In still other examples, a rules generator 520 analyzes account data 522 and/or response data 525 from the payer using one or more rule(s) 526 to identify a selected payment plan 528 for a specific payer. The account data in this example is downloaded from a data store or otherwise provided by the merchant.

The policy manager 110 optionally includes a query engine 530. The query engine 530 generates and/or updates a questionnaire 532 which is sent to the payer. The questionnaire 532 in some examples is a per-payer customized questionnaire. In other examples, the questionnaire 532 is customized on a per-merchant level. The questionnaire 532 includes one or more question(s) 534 to be answered by the payer. The questions are designed to obtain additional information from the payer regarding the specific circumstances which may have contributed to the payers account becoming delinquent. For example, if the payer lives in an area which has recently been hit by a natural disaster such as a tornado, the question(s) 534 may request information regarding whether the payer was negatively impacted by the tornado, whether the payer's home or business was damaged, etc. These payer-specific questions assist the policy manager in customizing a payment plan for the payer which is likely to be satisfactory to both the payer and the merchant payee.

In other examples, the policy manager 110 includes a metrics generator 540. The metrics generator 540 generates metrics associated with selected offers 548 and/or viewed offers 550. The metrics can include an acceptance rate 544 for offers and/or rejection rate for offers provided to payers. The metrics may be provided as a ranking, a percentage, or any other type of metric for rating the acceptance and rejections of offers. The metrics may be used to update/modify offers, as well as to increase selection of more popular (higher ranked) offers over other less popular offers.

In some examples, the metrics are generated for a reporting engine. For a selected policy, metrics indicate how many offers were viewed and how many offers were selected. For example, if a policy A is getting 60% of the acceptances and policy B is getting 10% of the acceptances, the metrics may indicate that policy B should be modified.

A payment service provider, in other examples, can provide notification to the policy manager and/or the merchant as to whether a payment has been received from the customer after the offer has been accepted and the billing triggered. In these examples, notification as to payment or non-payment can trigger cancellation of the accepted payment plan, modification of the payment plan or offer of a new/different payment plan to the customer.

FIG. 6 is an exemplary process flow chart 900 illustrating operation of a computing device to generate a customized smart collect policy for selecting payment plans. The process in FIG. 6 is implemented by a policy manager executing on a computing device, such as, but not limited to, the computing device 102 in FIG. 1, the computing device 211 in FIG. 2 and/or the computing device 302 in FIG. 3.

A determination is made whether a user is authenticated at 602. In this example, the user is a merchant or payee. If the user is not authenticated, the system can request credentials from the user at 604. The credentials can include a username, password, pin number, security questions, biometric data, or other authentication data. If the user is successfully authenticated, user data profile is updated at 606. The user data profile includes data associated with the user, such as, but not limited to, type of business, type of product, type of services, service areas, types of payments accepted by the user, etc. The system creates payment plans customized for the user based on the user data profile at 608. A customer questionnaire is created at 610. The questionnaire includes one or more questions for customer payers to answer if a customer account should become delinquent in payment (past due payment). The questionnaire can also include one or more predefined answers for the customer to choose from, such as a multiple-choice type of answer format. The policy manager builds rules at 612. The rules are rules for selecting payment plans, such as, but not limited to, the rules 526 in FIG. 5. A policy is created at 614. The policy includes the payment plans created for the user and the payment methods accepted by the user. The policy is deployed to generate customized payment plans for each user. The customized rules, account data for customers and policies for each user are stored in a data store at 616. The data store can include a data storage device, a cloud storage, or any other type of data store. The process terminates thereafter.

FIG. 7 is an exemplary flow chart 1000 illustrating operation of a computing device to provide a customized offer to a user. The computing device is a device such as, but not limited to, the computing device 102 in FIG. 1, the computing device 211 in FIG. 2 and/or the computing device 302 in FIG. 3.

Customer credentials are received at 702. The credentials can include a username, password, biometric data, pin number or any other type of credentials to authenticate the user. In this example, the user is a customer or payer associated with a payment account that has a past due payment. The customized policy of the merchant/payee is applied at 704 to select a customized payment plan for the customer at 706. The offer including the selected payment plan and payment method(s) is presented to the customer at 708. A determination is made whether the customer accepted the offer at 710. If yes, billing in accordance with the new payment plan payment terms is triggered at 712. The process terminates thereafter.

FIG. 8 is an exemplary flow chart 1100 illustrating operation of a computing device to use a customized policy for selecting payment plans and payment methods for delinquent user accounts. The computing device is a device such as, but not limited to, the computing device 102 in FIG. 1, the computing device 211 in FIG. 2 and/or the computing device 302 in FIG. 3.

A payer is identified at 802. In some examples, the payer is identified based on customer credentials provided during user login to the merchant website or portal page. Account data for the payer is retrieved at 804. The account data in some examples is retrieved from a data store, such as a data storage device or cloud storage. A questionnaire is sent to the payer at 806. A determination is made whether responses are received back from the payer at 808. In some examples, the responses are received from a user interface via a network. If no, the account data is analyzed without the responses at 810. If responses are received, the account data and the response data are analyzed at 812. The customize policy is applied at 814. The policy includes the set of rules and the payment plans created for the payee merchant. The policy is applied to select a payment plan and at least one payment method at 816. The offer including the selected payment plan and payment method is sent to the payer at 818. The process terminates thereafter.

FIG. 9 is an exemplary flow chart 1200 illustrating operation of a computing device to obtain user response data and offer acceptance data associated with a customized payment offer. The computing device is a device such as, but not limited to, the computing device 102 in FIG. 1, the computing device 211 in FIG. 2 and/or the computing device 302 in FIG. 3.

The process begins by determining if a user is authenticated at 90. If no, the credentials can be requested at 904. If the user is authenticated, a questionnaire is presented to the user at 906. A determination is made whether the questionnaire is completed at 908. If yes, a determination is made whether an offer is generated for the user at 910. If yes, the offer is presented at 912. A determination is made whether the offer is accepted at 914. If yes, an offer accepted is sent at 916. If no, an offer rejected is sent to the policy manager at 918. The process terminates thereafter.

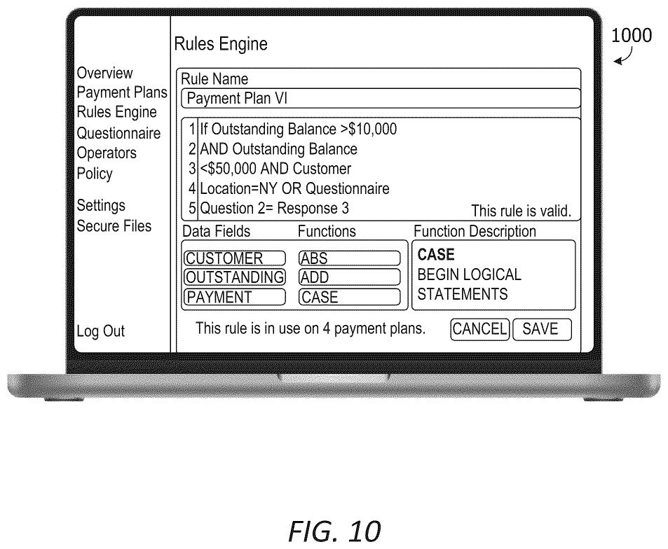

FIG. 10 is an exemplary UI 1000 including a set of rules applied to user data to select a customized payment plan for a user. In this example, the rules engine includes a set of customized rules for selecting payment plans for users. In this example, one rule states that if a payer's outstanding balance is more than $10,000 and less than $50,000 and the customer's location is New York or the questionnaire response to question two is response number three, a given payment plan IV is selected.

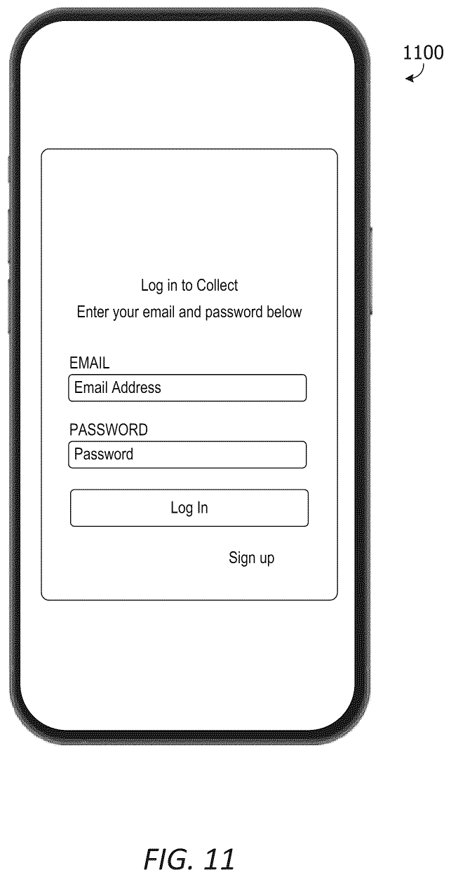

FIG. 11 is an exemplary UI 1100 including a user login screen for authenticating a user that is currently delinquent in one or more payments to a payee (merchant). In this non-limiting example, a user login provides credentials for authenticating a user. The UI 1100 depicts a mobile login for a merchant user to access the policy manager (collect UI) in order to update policies, view reporting, etc. The credentials can also include credentials for a merchant payee setting up a customized policy.

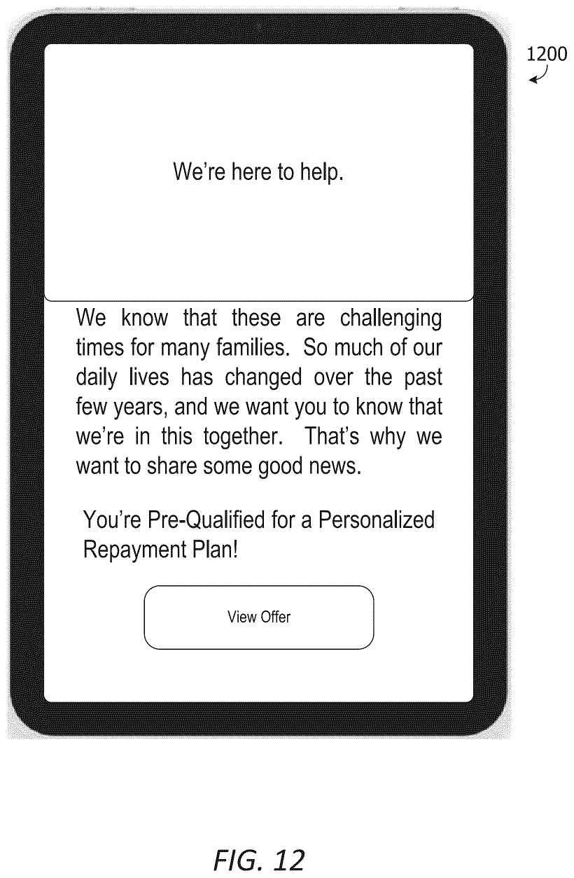

FIG. 12 is an exemplary UI 1200 of a pre-qualified repayment plan offer notification The notification in this example indicates that the user is prequalified to receive a customized payment plan offer based on the user's account data. The user may be requested to provide additional information in a questionnaire before an offer is presented to the user. In this example, the UI 1200 depicts post-user log in to the merchant's website, which has already received the policy API response to then allow the merchant's hosted UI to deliver the prequalified payment plan message to the payer/user.

### Exemplary Operating Environment

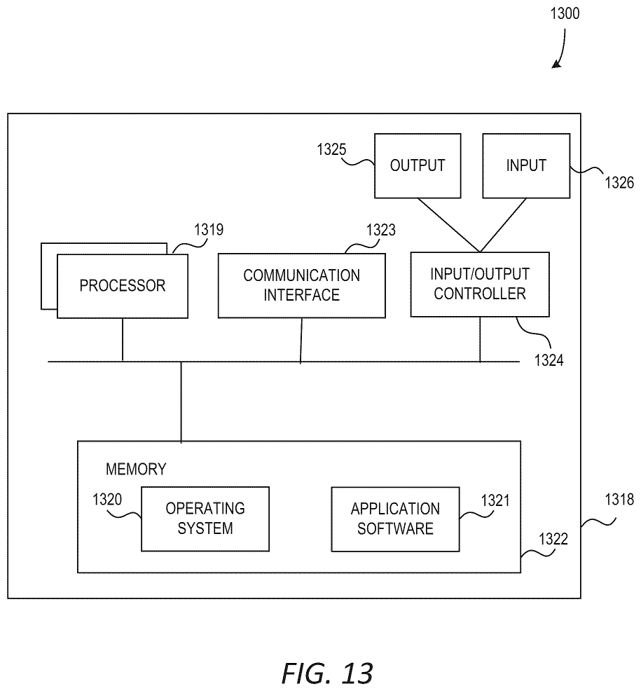

The present disclosure is operable with a computing apparatus according to an embodiment as a functional block diagram of a computing apparatus 1300 in FIG. 13. In an embodiment, components of a computing apparatus 1300 may be implemented as a part of an electronic device according to one or more embodiments described in this specification. The computing apparatus 1300 comprises one or more processors 1319 which may be microprocessors, controllers, or any other suitable type of processors for processing computer executable instructions to control the operation of the electronic device. Alternatively, or in addition, the processor 1319 is any technology capable of executing logic or instructions, such as a hardcoded machine. Platform software comprising an operating system 1320 or any other suitable platform software may be provided on the apparatus 1300 to enable application software 1321 to be executed on the device.

Computer executable instructions may be provided using any computer-readable media that are accessible by the computing apparatus 1300. Computer-readable media may include, for example, computer storage media such as a memory 1322 and communications media. Computer storage media, such as a memory 1322, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus.

In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1322) is shown within the computing apparatus 1300, it will be appreciated by a person skilled in the art, that the storage may be distributed or located remotely and accessed via a network or other communication link (e.g., using a communication interface 1323).

The computing apparatus 1300 may comprise an input/output controller 1324 configured to output information to one or more output devices 1325, for example a display or a speaker, which may be separate from or integral to the electronic device. The input/output controller 1324 may also be configured to receive and process an input from one or more input devices 1326, for example, a keyboard, a microphone, or a touchpad. In one embodiment, the output device 1325 may also act as the input device. An example of such a device may be a touch sensitive display. The input/output controller 1324 may also output data to devices other than the output device, e.g., a locally connected printing device. In some embodiments, a user may provide input to the input device(s) 1326 and/or receive output from the output device(s) 1325.

The functionality described herein can be performed, at least in part, by one or more hardware logic components. According to an embodiment, the computing apparatus 1300 is configured by the program code when executed by the processor 1319 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example computer system comprises: at least one processor; and at least one memory comprising computer program code, the at least one memory and the computer program code configured to, with the at least one processor, cause the at least one processor to: apply a customized set of rules to user account data associated with a delinquent account having a past-due amount owed by a user; select a payment plan from a plurality of payment plans and at least one payment method from a plurality of payment methods based on a result of the application of the customized set of rules; generate an offer including the selected payment plan and the at least one payment method; and present the offer to the user via a user interface device for acceptance or rejection, the offer providing at least one payment term for at least partially satisfying a past-due amount owed by the user, wherein user acceptance of the offer triggers an account status change from delinquent to non-delinquent.

One or more exemplary non-transitory computer readable storage media comprise computer-executable instructions for a smart collect manager that, upon execution by a processor, cause the processor to at least: apply a customized set of rules to user account data associated with a delinquent account having a past-due amount owed by a user; select a payment plan from a plurality of payment plans and at least one payment method from a plurality of payment methods based on a result of the application of the customized set of rules; generate an offer including the selected payment plan and the at least one payment method; and present the offer to the user via a user interface device for acceptance or rejection, the offer providing at least one payment term for at least partially satisfying a past-due amount owed by the user, wherein user acceptance of the offer triggers an account status change from delinquent to non-delinquent.

In an example scenario, if a user account has an outstanding balance of $5,000 and the last payment is ten days past due, one rule may state that if the user has been past due on previous payment before then payment plan A is selected but if the user has never been past due on previous payment before payment plan B is selected. In other examples, the rules may direct selection of payment plans based on factors such as the products purchased, the payer's location, payment history, total outstanding balance, amount due, statement date, previous due date, last payment amount, number of days past due, etc. The rules can also be applied based on merchant-defined custom variables, such as product SKU, product category, category of product, type of product, etc. The rules are used to select a payment plan and/or payment method.

In another example, if a user account satisfies or hits rule A, the user qualifies for payment plan one and the user is permitted to use a bank account, credit card or cryptocurrency to make payments. If the user account hits rule B, payment plan two is selected and the user is permitted to use buy now/pay later or a cryptocurrency account as payment options. This allows more options for users to self-cure delinquent accounts while being less confrontational and providing a better experience for both customers and merchants. The process is less time consuming for merchants enabling greater flexibility to customize payment plan options based on additional choices through the policy.

In some examples, a user utilizes a policy deployment page to create the rules and payment plans which combine into a policy. The policy deployment page is accessed via a client facing user interface used to create the rules. A customer facing API is used to obtain customer responses to the questionnaire and provide offers to customers.

In an example scenario, a company signed up for policy manager to help improve their customer satisfaction scores, decrease delinquent payments, and decrease staff time managing collection activity and outbound communication efforts. If a small business owner working with ABC Co. experiences an unfortunate circumstance that makes it difficult to keep up with outstanding invoices to ABC Co. causes the small business owner to become 90 days past-due on payments. Based on ABC Co's deployed collect policy, ABC Co. triggers a non-confrontational message to the small business owner that they understand the situation and want to help. The small business owner logs into ABC Co's portal page and completes the questionnaire outlining the circumstances and preferred payment method. ABC Co. displays a curated payment plan the small business owner can afford. A few months later, the small business owner is back to current, and the small business is thriving. The small business owner refers other small business owners to ABC Co. as a result of the positive experience working with ABC Co. Likewise, ABC Co. reduces manual processes and increases customer satisfaction due to this customer-first lens on payment collection, further a financial inclusivity.

Alternatively, or in addition to the other examples described herein, examples include any combination of the following:
trigger billing of the user account in accordance with the at least one payment term;
generate, by a payee of the user account, the customized set of rules and the plurality of payment plans based on at least one template provided by a smart collect policy manager;
call the mart collect policy manager associated with a cloud server, by a policy application programming interface (API) in response to authenticating credential of the user logging into a payee web site;
provide a questionnaire comprising a set of questions and a set of possible responses to the set of questions to a user device associated with the user;
receive response data including user-selected responses to the set of questions from the user device via a network;
generate metric data associated with a rate of acceptance of at least one payment plan in the plurality of payment plans by a plurality of users presented with the at least one payment plan;
updating the at least one payment plan in response to the rate of acceptance falling below a minimum threshold value; and
update, by a machine learning component, at least one payment plan in the plurality of payment plans to improve an acceptance rate associated with the at least one payment plan.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for applying a customized set of rules to user account data associated with a delinquent account having a past-due amount owed by a user; exemplary means for selecting a payment plan from a plurality of payment plans and at least one payment method from a plurality of payment methods based on a result of the application of the customized set of rules; exemplary means for generating an offer including the selected payment plan and the at least one payment method; and exemplary means for presenting the offer to the user via a user interface device for acceptance or rejection, the offer providing at least one payment term for at least partially satisfying a past-due amount owed by the user, wherein user acceptance of the offer triggers an account status change from delinquent to non-delinquent.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for customized rules-based payment plan management, the system comprising:
at least one processor; and
at least one memory comprising computer-readable instructions, the at least one processor, the at least one memory and the computer-readable instructions configured to cause the at least one processor to:
apply a customized set of rules to user account data associated with a delinquent account having a past-due amount owed by a user;
select a payment plan from a plurality of payment plans and at least one payment method from a plurality of payment methods based on a result of the application of the customized set of rules;
generate an offer including the selected payment plan and the at least one payment method; and
present the offer to the user via a user interface device for acceptance or rejection, the offer providing at least one payment term for at least partially satisfying a past-due amount owed by the user, wherein user acceptance of the offer triggers an account status change from delinquent to non-delinquent.

2. The system of claim 1, wherein the computer-readable instructions further cause the at least one processor to:
trigger billing of the user account in accordance with the at least one payment term.

3. The system of claim 1, wherein the computer-readable instructions further cause the at least one processor to:
generate, by a payee of the user account, the customized set of rules and the plurality of payment plans based on at least one template provided by a smart collect policy manager.

4. The system of claim 1, wherein the computer-readable instructions further cause the at least one processor to:
execute a smart collect policy manager associated with a cloud server, by a policy application programming interface (API), in response to authenticating a credential of the user logging into a payee website.

5. The system of claim 1, wherein the computer-readable instructions further cause the at least one processor to:
provide a questionnaire comprising a set of questions and a set of possible responses to the set of questions to a user device associated with the user; and
receive response data including user-selected responses to the set of questions from the user device via a network.

6. The system of claim 1, wherein the computer-readable instructions further cause the at least one processor to:
generate metric data associated with a rate of acceptance of at least one payment plan in the plurality of payment plans by a plurality of users presented with the at least one payment plan; and
update the at least one payment plan in response to the rate of acceptance falling below a minimum threshold value.

7. The system of claim 1, wherein the computer-readable instructions further cause the at least one processor to:
update, by a machine learning component, at least one payment plan in the plurality of payment plans to improve an acceptance rate associated with the at least one payment plan.

8. A method for customized rules-based payment method and payment plan management, the method comprising:
selecting a payment plan from a plurality of payment plans based on a result of application of a set of customized rules to user account data associated with a delinquent account having a past-due amount owed by a user;
generating an offer including the selected payment plan and a payment method;
presenting the offer to the user via a user interface for acceptance or rejection, wherein the offer comprises the selected payment plan and a payment method for at least partially satisfying the past-due amount; and
changing an account status of the delinquent account from delinquent status to non-delinquent status responsive to acceptance of the offer.

9. The method of claim 8, further comprising:
presenting a set of available rules for application to user account data associated with a delinquent account having a past-due amount owed by a user, the set of customized rules comprising data fields and functions;
receiving a configuration of text values, numerical values, question identifiers, response identifiers, operators, the data fields, and the functions; and
constructing the set of customized rules based on the received configuration.

10. The method of claim 8, further comprising:
generating, by a payee of the user account, the set of customized rules and the plurality of payment plans based on at least one template provided by a smart collect policy manager.

11. The method of claim 8, wherein the selected payment plan includes a payment term, and further comprising:
triggering billing of the user account in accordance with the payment term.

12. The method of claim 8, further comprising:
presenting a questionnaire comprising a set of questions and a set of possible responses to the set of questions to a user device associated with the user; and
receiving response data including user-selected responses to the set of questions from the user device via a network.

13. The method of claim 8, further comprising:
generating metric data associated with a rate of acceptance of at least one payment plan in the plurality of payment plans by a plurality of users presented with the at least one payment plan; and
updating the at least one payment plan in response to the rate of acceptance falling below a minimum threshold value.

14. The method of claim 8, further comprising:
updating, by a machine learning component, at least one payment plan in a plurality of payment plans to improve an acceptance rate of the at least one payment plan by users.

15. A computer storage medium having computer-executable instructions that, upon execution by a processor of a computer, cause the processor to at least:
present a plurality of available rules for application to account data associated with a delinquent account having a past-due amount owed by a first user;
construct a set of customized rules from the plurality of available rules based on a configuration received from a second user;
apply the set of customized rules to user account data associated with a delinquent account having the past-due amount owed by the first user;
select a payment plan from a plurality of payment plans based on a result of application of the set of customized rules to the account data; and
present an offer to the first user via a user interface for acceptance or rejection, wherein the offer comprises the selected payment plan and a payment method for at least partially satisfying a past-due amount owed by the first user.

16. The computer storage medium of claim 15, wherein the instructions, when executed by a processor of the computer, cause the computer to:
trigger billing of the account in accordance with a payment term of the selected payment plan.

17. The computer storage medium of claim 15, wherein the instructions, when executed by a processor of the computer, cause the computer to further perform:
generate, by the second user, the set of customized rules and the plurality of payment plans based on at least one template provided by a smart collect policy manager.

18. The computer storage medium of claim 15, wherein the instructions, when executed by a processor of the computer, cause the computer to further perform:
provide a questionnaire comprising a set of questions and a set of possible responses to the set of questions to a user device associated with the first user; and
receive response data including user-selected responses to the set of questions from the user device via a network.

19. The computer storage medium of claim 15, wherein the instructions, when executed by a processor of the computer, cause the computer to further perform:
generate metric data associated with a rate of acceptance of at least one payment plan in the plurality of payment plans by a plurality of users presented with the at least one payment plan; and
update the at least one payment plan in response to the rate of acceptance falling below a minimum threshold value.

20. The computer storage medium of claim 15, wherein the instructions, when executed by a processor of the computer, cause the computer to further perform:
update at least one payment plan in the plurality of payment plans automatically by a machine learning component to improve an acceptance rate associated with the at least one payment plan.
